(19) United States
(12) Patent Application Publication
(10) Pub. No.: US 2025/0203210 A1
(43) Pub. Date: Jun. 19, 2025

(54) ADJUSTABLE IMAGING DEVICE DESIGNED FOR EFFICIENCY AND RELIABILITY

(71) Applicant: CARBON STEALTH DESIGNS, LLC, Ada, MI (US)

(72) Inventors: Matthew Scott Toburen, Ada, MI (US); Nicholas Bowers, Fontana, WI (US); William Vining, Roswell, GA (US)

(21) Appl. No.: 18/985,625

(22) Filed: Dec. 18, 2024

Related U.S. Application Data
(60) Provisional application No. 63/611,536, filed on Dec. 18, 2023.

(51) Int. Cl. H04N 23/695; H04N 23/61; H04N 23/661

(52) U.S. Cl. CPC H04N 23/695; H04N 23/61; H04N 23/662

(57) ABSTRACT

The present disclosure provides a system for tracking and monitoring. The system can include a track system, a chassis, and a control system. The chassis can be adapted to traverse along the track system. The chassis can include a chassis body and an image capture housing. The chassis body can have a drive system for propelling the chassis along the track system, a power source, and a guide wheel adapted to interface with the track system. The image capture housing can be disposed adjacent the chassis body and selectively movable between a first position and a second position. The image capture housing can include an imaging device. The control system can be in wireless communication with the chassis for navigation and imaging device.

### CROSS-REFERENCE TO RELATED APPLICATIONS

This application claims the benefit of U.S. Provisional Application No. 63/611,536, filed on Dec. 18, 2023. The entire disclosure of the above application is incorporated herein by reference.

### FIELD

The present technology relates to the field of inventory monitoring, tracking and security systems, and more specifically to an automated information acquisition system for persistent monitoring in a commercial space.

### INTRODUCTION

This section provides background information related to the present disclosure which is not necessarily prior art.

Various methods have been explored for autonomous and on-demand inventory tracking in an industrial environment, including the use of an unmanned aerial or floor-based vehicle, a fixed camera, and a QR code. However, existing solutions have drawbacks like high operating costs, frequent maintenance needs, insufficient reliability, and poor adaptability as infrastructure evolves. This has necessitated the pursuit of a more robust and practical approach.

Inventory and security monitoring in a large industrial environment such as a warehouse, a distribution center, and a retail store relies on static solutions like fixed security cameras and manual audits. These approaches have several drawbacks. Limited visual coverage is one issue that is known, particularly with fixed camera positioning. A static camera only provides visibility for its fixed field of view, creating blind spots. A human guard or auditor can only directly observe a small, localized area at any given time, leaving other areas not actively being monitored at risk for a security incident.

Another drawback is the labor-intensive nature of a physical security patrol and manual inventory check, which require significant labor, yet only offer a periodic snapshot of an area rather than continuous monitoring and tracking. Furthermore, physical security patrol and manual inventory checks can be subject to human error related to observations and/or recording and communicating such observations.

Additionally, with intermittent monitoring methods, an event like an inventory irregularity or a security breach can go undetected for longer periods of time resulting in delayed detection and reduced operational efficiency. A further weakness is the limited analytics and intelligence possible with simple static cameras and human observations. Advanced analysis like item identification, counting, and tracking is challenging when using manual observation. Lack of persistent visibility also limits the ability to collect and analyze security and inventory data over longer time spans.

Accordingly, there is a continuing need for a system and method that overcomes these deficiencies by introducing an intelligent, versatile chassis that can traverse large operating spaces and adjust viewing positions to optimize the viewing area.

### SUMMARY

In concordance with the instant disclosure, for a system and method that overcomes these deficiencies by introducing an intelligent, versatile chassis that can traverse large operating spaces, adjusting a position as needed, has surprisingly been discovered.

In certain embodiments, the present disclosure provides a system for tracking and monitoring including a track system, a chassis, and a control system. The chassis can be adapted to traverse along the track system. The chassis can include a chassis body and an image capture housing. The chassis body can have a drive system for propelling the chassis along the track system, a power source, and a guide wheel adapted to interface with the track system. The image capture housing can be disposed adjacent the chassis body and selectively movable between a first position and a second position. The image capture housing can include an imaging device. The control system can be in wireless communication with the chassis for navigation and imaging device.

In certain embodiments, a method for tracking and monitoring a space is provided. The method can include providing a chassis adapted to traverse along a track system and equipping the chassis with an imaging device adjustably mounted to the chassis. The imaging device can be configured to be raised, lowered or pivoted for positioning in operation. The chassis can be wirelessly connected to a control system for navigation and imaging device positioning. The control system can autonomously position the chassis and imaging device within the space for imaging device.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic depicting a system for tracking and monitoring;

FIG. 2 is bottom perspective view of the system according to FIG. 1, shown in a first position and a second position;

FIG. 3 is a left-side, top perspective view of the system according to FIG. 1, shown in a first position and a second position;

FIG. 4 is a right-side, top perspective view of the system according to FIG. 1, shown in a first position and a second position;

FIG. 5 is a top perspective view of the system, according to another embodiment;

FIG. 6 is a left side elevational view of the system according to FIG. 5;

FIG. 7 is an environmental view of the system according to FIG. 1 in use in a warehouse setting;

FIG. 8 is an environmental view of the system according to FIG. 1 in use in a warehouse, library, or retail setting;

FIG. 9 is an environmental view of the system according to FIG. 5 in use in an outdoor environment;

FIG. 10 is a system schematic showing various applications of the system of FIG. 1; and

FIG. 11 is a flowchart depicting a method of tracking and monitoring using a chassis and a control system.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

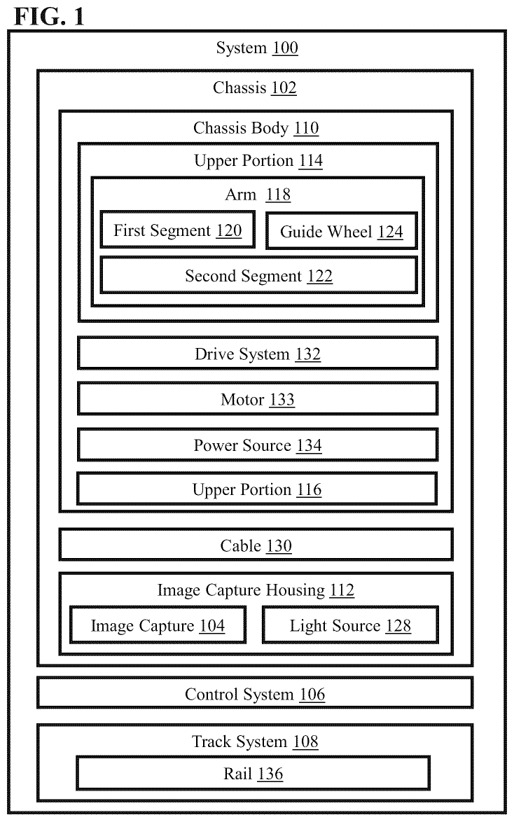

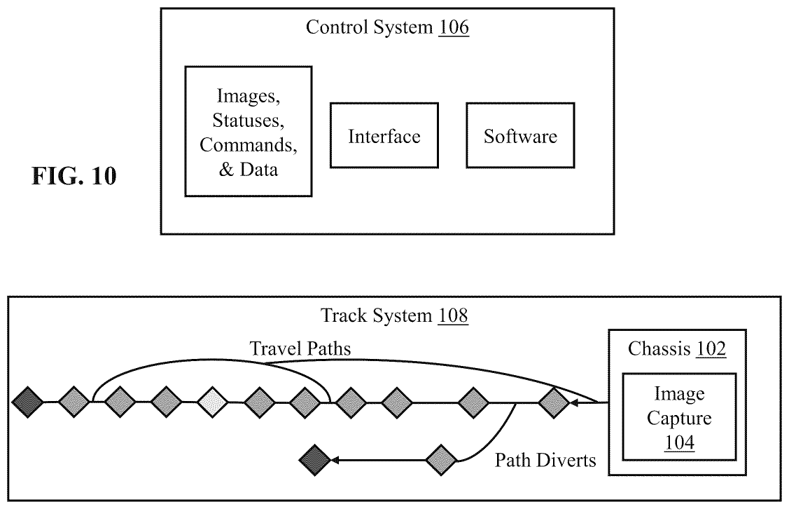

The present technology improves upon existing solutions for inventory and asset tracking and security in an industrial environment by introducing a versatile chassis that can autonomously traverses operating spaces while adjusting positions as needed, with computer vision capabilities and continuous mobility that enables persistent wide-area monitoring with more advanced analytics potential than previously feasible. The present disclosure provides a system 100, as shown generally in FIGS. 1-9 and a method 200 for tracking and monitoring, as shown generally in FIG. 10. The system 100 can include a chassis 102, an imaging device 104, and a control system 106. The chassis 102 and the imaging device 104 can be in communication with the control system 106. The control system 106 can navigate the chassis 102 about a track system 108 and control the movement of and actuation of the imaging device 104.

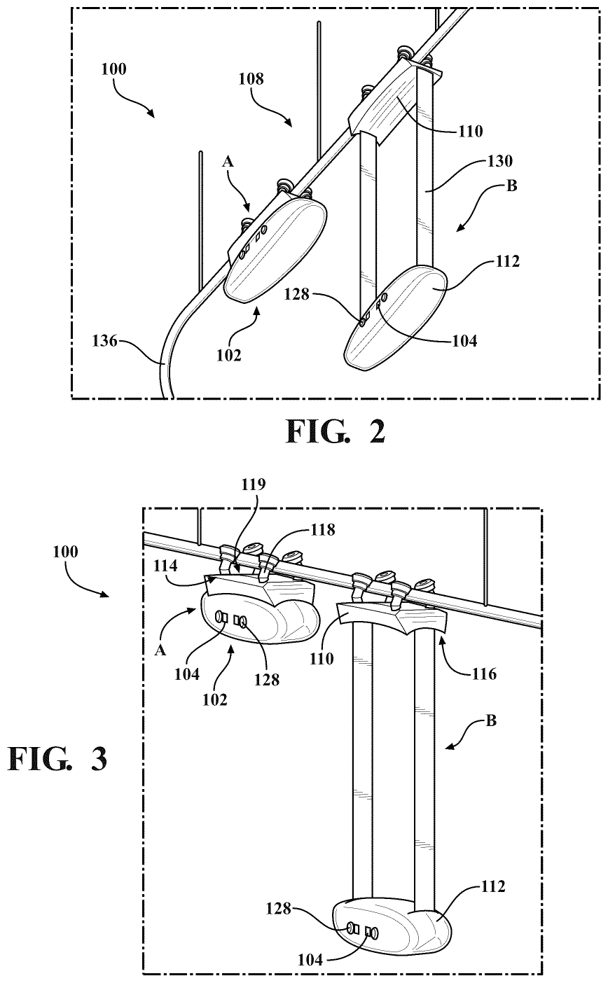

As shown in FIGS. 1-4, the chassis 102 can include a chassis body 110 and an image capture housing 112. The image capture housing 112 can be disposed adjacent to the chassis body 110 and can be selectively movable based on a command provided by the control system 106. The chassis body 110 can have an upper portion 114 and a lower portion 116. The chassis body 110 can include an arm 118 disposed on opposing sides of the upper portion 114. In certain embodiments, the arm 118 can include a first segment 120 disposed at an angle 121 relative to the chassis body 110, as shown in FIG. 5. The arm 118 can include a second segment 122 disposed at a second angle 123 relative the first segment 120. The arm 118 can include a guide wheel 124 having a longitudinal axis 125 disposed in a plane parallel with the first segment 120. With renewed reference to FIG. 3, the arms 118 can create a cavity 119 between the chassis body 110 and the guide wheel 124 that can receive the track system 108 and the guide wheel 124 can be disposed on the track system 108. A portion of the guide wheel 124 can contact the track system 108 in operation and allow the chassis 102 to move along the track system 108. In certain embodiments, and as shown in FIGS. 2-6, the chassis 102 can include more than one arm 118 disposed on the upper portion 114 of the chassis body 110 with each arm including the guide wheel 124 for contacting the track system 108. It should be understood the guide wheel 124 can be a driven wheel where an electric motor or other suitable drive mechanism can be utilized to rotate the guide wheel 124 with respect to the track system to propel the chassis 102 along the track system 108. The guide wheel 124 can include a rubberized or elastomeric surface for contacting the track system 108 and providing a desired level of rolling frictional contact with the track system 108 and militate against the chassis 102 moving along the track system 108 involuntarily. A skilled artisan can select a suitable number of arms 118 and guide wheels 124 for the chassis 102 within the scope of the present disclosure.

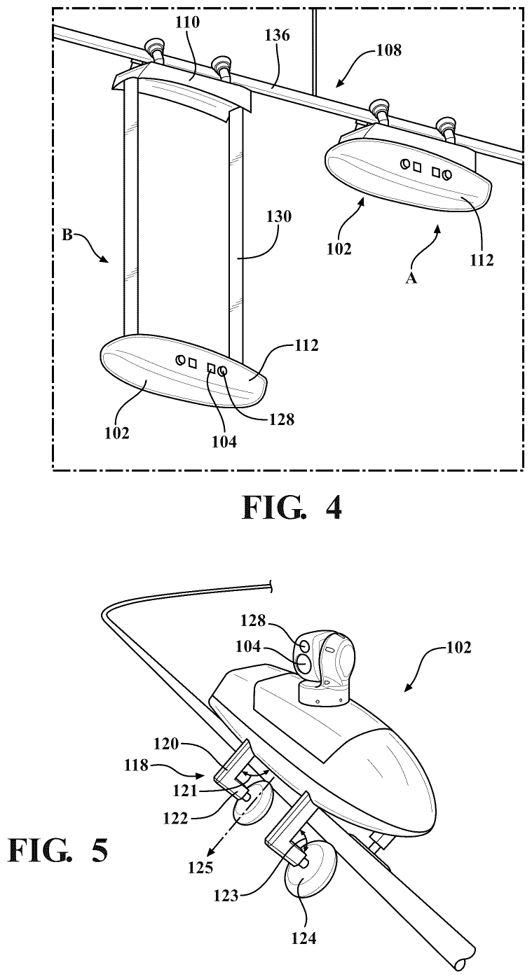

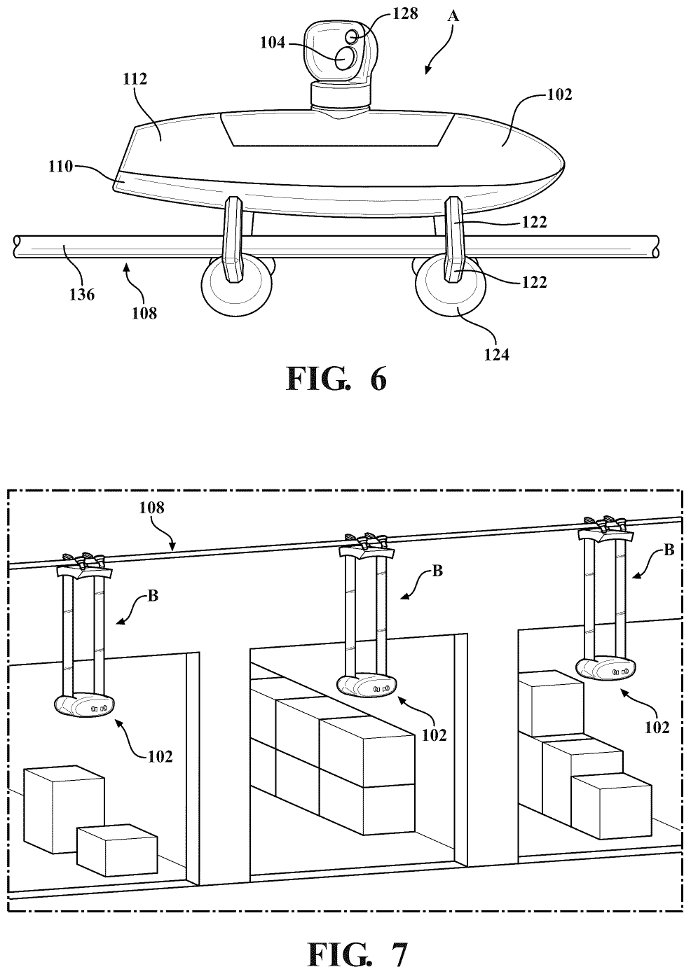

With reference to FIGS. 4-5, the image capture housing 112 can include the imaging device 104 and a light source 128. The imaging device 104 can be coupled to the image capture housing 112 to allow for versatile monitoring and data collection capabilities in operation. The image capture housing 112 can include multiple imaging devices 104 to allow for nearly 360° monitoring around the chassis 102. With reference to the example shown in FIGS. 2-4, the image capture housing 112 can include at least two imaging devices 104 on each side of image capture housing 112 for a total of four imaging devices 104 on the system 100. It should be understood that one or more of the light sources 128 can be provided for each imaging device 104 included with the image capture housing 112. In another example shown in FIGS. 5-6, the image capture housing 112 can include a rotatable imaging device 104 disposed centrally on the image capture housing 112 and configured to rotate in operation to provide for a 360° field of view. The rotatable imaging device 104 can include one or more of the light sources 128. A skilled artisan can select a suitable number of imaging devices 104 and configurations thereof within the scope of the present disclosure.

The image capture housing 112 can be selectively movable between a first position (A) adjacent the chassis body 110, as shown on the left in FIGS. 2-3, and a second position (B) spaced apart from the chassis body 110, as shown on the right in FIGS. 2-3. It should be appreciated that the second position (B) can be any position spaced apart from the chassis body 110 and therefore, during operation, the second position (B) can change dependent upon where monitoring and/or image capturing is required. The image capture housing 112 can be raised and lowered to achieve optimal positioning for capturing images and video within the monitored space.

The movement between the first position (A) and the second position (B) can be facilitated through a cable 130 coupled to the chassis body 110 and the image capture housing 112. As shown in FIG. 2, the chassis 102 can include multiple cables 130 for coupling the chassis body 110 and the image capture housing 112. The cable 130 can be any flexible cable that allows for communication between the imaging device 104 and the control system 106. As an example, the cable 130 can include a ribbon cable. In a particular example, the cable 130 can include the WAVELINK® Flat Flexible Cable sold by WAVELINK® of Manchester New Hampshire. Advantageously, the ribbon cable can militate against twisting during deployment and positioning operations. It should be appreciated that, in certain embodiments, the cable 130 can be a non-communicating cable such that the communication between the chassis body 110, the image capture housing 112, and the control system 106 are wireless. A skilled artisan can select a suitable cable 130 within the scope of the present disclosure.

The chassis 102 can include a motor and drum mechanism for moving the image capture housing 112 between the first position (A) and the second position (B) upon receiving the command by the control system 106. The cable 130 can have a variable length to allow for the image capture housing 112 to be selectively moved from the first position (A) to the second position (B). Where the image capture housing 112 is in the first position (A) and the cable 130 is not in use to move the image capture housing 112 to the second position (B), the cable 130 can be disposed within the chassis body 110 or the image capture housing 112 utilizing a reel or spool, for example. Although the cable 130 is not employed to provide the movement of the image capture housing 112 in the first position (A), it should be appreciated that the cable 130 can continue to provide a communication path between the control system 106 and the imaging device 104 to allow for the system 100 to operate while in the first position (A).

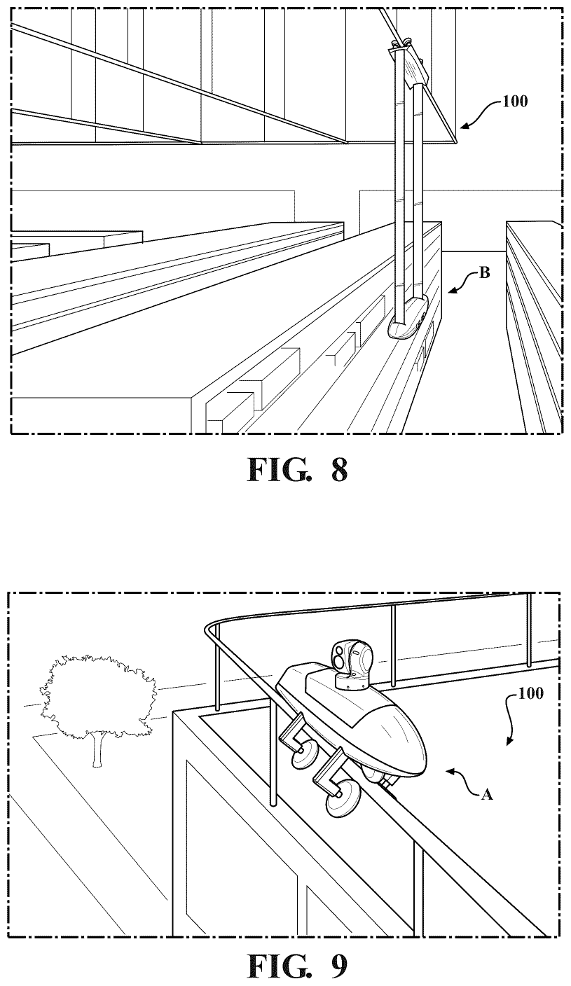

With reference to FIGS. 7-8, the imaging device 104 can be configured to produce high-quality imagery from a predetermined distance away from the image capture housing 112. For example, the predetermined distance can be between about 5 feet and about 6 feet, which is optimal for monitoring standard warehouse aisles. When positioned in the center of an aisle, the system 100 can effectively capture images of inventory locations on both sides. The imaging device 104 can be configured to capture between about 1000 images to about 2000 images per hour, or more, enabling comprehensive visual documentation of large spaces. The imaging device 104 can be configured to capture different sized areas, from standard 48 by 40 inch inventory locations to larger 8 by 8 foot sections, for example, allowing for flexible monitoring capabilities. The imaging device 104 can include various types of cameras and sensors based on specific monitoring needs, including 3D cameras, stereo cameras, depth sensors, an RFID sensor, and a QR code reader, as examples. It should be understood that a single image capture housing 112 can include more than one type of camera and/or sensors to provide multiple monitoring format capabilities in the single image capture housing 112. A skilled artisan can select a suitable imaging device 104 within the scope of the present disclosure. By utilizing different types of imaging device 104, the system 100 can be adapted to different use cases and environments while maintaining high-quality data collection capabilities.

It should be appreciated that the system 100 is capable of processing raw information via the software, which can be open source and/or coded to make the image collected into a usable and/or processable image. In this way, the system 100 ability of the system is broadened to use any imaging device 104 regardless of the sensors of imaging device 104 and imaging software capabilities. It should also be appreciated that advanced imaging capabilities can be integrated into the imaging device 104, including infrared and thermal cameras for enhanced visibility in low-light conditions or through obscurants. Additionally, the imaging device 104 can utilize a global and rolling shutter, enabling the chassis 102 to continue moving while capturing clear, undistorted images.

It should be further appreciated that due to the applicability of the system 100 in a warehouse setting, the imaging device 104 can be configured to read a string of characters, such as a bar code or inventory label, from the predetermined distance. To provide readability at the predetermined distance, the string of characters can be on a label of at least about 1 inch by about 3 inches, for example. In certain embodiments, the imaging device 104 can include a magnification lens for enlarging the image captured while in operation. Advantageously, the imaging device 104 can read the string of characters from the predetermined distance without requiring post capture enlarging of the string of characters. The control system 106 can utilize a bar code, an RFID tag, or a QR code to facilitate inventory applications. Additionally, the system 100 can utilize computer vision and an artificial intelligence (AI) model to facilitate inventory management.

The system 100 can incorporate AI capabilities both onboard the chassis and at the edge computing level. The control system 106 can utilize machine learning algorithms for real-time object detection, classification, and recognition of items, equipment, conditions, text, barcodes, and environments to inform various business functions. By processing data at the control system 106 where the chassis 102 is in operation rather than transmitting raw feeds, the system 100 can filter and enroll relevant findings into backend databases, workflows, and processes with minimal latency. The AI system can integrate with external analytics platforms to enable automated data capture through optical, sensor, and IoT technologies for various inspection, identification, counting, and analytics needs. The integration allows leveraging advanced automation techniques like machine learning, computer vision, and predictive modeling as modular add-ons to the core mobile camera capabilities. For example, the system 100 can interface with inventory management platforms to autonomously scan shelf contents and feed resulting object detections to optimize reordering.

The AI capabilities extend to computer vision functionality, where the system 100 uses trained models to perform inventory management tasks on an edge device processing the captured images. The system 100 can read strings of characters and barcodes from the predetermined distance, with the AI model trained to identify and process inventory labels of varying sizes. As models improve through retraining on growing data, identification accuracy increases, enabling more sophisticated analysis of captured imagery. The centralized AI architecture enables more efficient processing while reducing power consumption on individual units, while still maintaining high-speed communication for real-time analysis and response.

With reference to FIG. 7, the light source 128 for providing light for the imaging device 104 in operation, particularly during operations in low-light conditions or during off-hours monitoring when the facility can have reduced lighting. Advantageously, the light source 128 can allow for the system 100 to operate autonomously during off-hours when there may be a need to provide lighting to maintain consistent image quality for inventory tracking and security monitoring purposes. The light source 128, as a component of the chassis 102, can be controlled by the control system 106 to allow for the light source 128 to be controlled and changed while the chassis 102 is in operation and not housed with the control system 106.

It should be appreciated that the chassis 102 can include various onboard equipment to enhance monitoring and operation of the system 100. The chassis 102 can include onboard computing capability mounted directly on the chassis 102, though, as described herein, in certain embodiments the computing resources can be located in the control system 106 separate from the chassis 102. The chassis 102 can include lighting equipment to support imaging device functions during low-light conditions and off-hours monitoring when facility lighting may be reduced. Additionally, the chassis 102 can be configured with LiDAR equipment for spatial mapping and navigation purposes, enhancing the ability to traverse the track system, maintain positioning, and militate against contact with other objects. The system can also include audio equipment alongside other monitoring devices, allowing for data collection across different operational environments and/or audible signals to alert humans of the presence and/or movement of the chassis 102. The various equipment options enable the chassis 102 to adapt to different monitoring requirements while maintaining efficient operation through centralized control and power management.

It should be appreciated that the control system 106 can manage the imaging device process, storing and processing the collected visual data while integrating with an external analytic platform that leverages machine learning for advanced functions like object identification and tracking. The combination of mobility and advanced imaging capability can enable the system 100 to provide persistent monitoring without blind spots, making it the system 100 effective for inventory management, security surveillance, and infrastructure monitoring applications.

The chassis 102 can include a drive system 132 for propelling the chassis 102 along the track system and an onboard power source 134 for powering drive system 132 and other components of the chassis 102. As described herein, the drive system 132 can incorporate a motor 133 having sensing capabilities that enable precise control and positioning along the track. The motor can provide exact measurements in radians for movement tracking, though the system 100 can rely on other components, such as the control system 106, in addition to the motor for navigation. A skilled artisan can select a suitable navigation means for the system 100 within the scope of the present disclosure.

The chassis 102 can achieve varying speeds, transitioning between speeds depending upon where the chassis 102 is on the track system 108 and based on a magnetic marker on the track system 108 detected during navigation of the chassis 102. The operation and speed produced by the drive system 132 can be managed by the control system 106, which can employ an algorithm for energy efficiency and collision avoidance where multiple chassis 102 are operating on the track system 108 and further enables coordinated movement of multiple chassis 102 while maintaining distance between each chassis 102 and optimal positioning for monitoring tasks.

The chassis 102 can include the onboard power source 134, which can be managed by the control system 106. The power source 134 can support continuous operation, with the control system 106 utilizing algorithms to manage battery charging for the entire fleet of chassis 102. The algorithm employed by the control system 106 can balance the power requirement for upcoming monitoring with the available charging capacity throughout an operational period. The control system 108 can coordinate charging by managing when units return to protective storage areas, where the batteries can be automatically recharged without human intervention. The control system 108 can consider multiple factors with respect to the power source 134 including the number of chassis 102 in use, power source 134 capacity, a power consumption rate for the power source 134, battery charging rate, and charging station availability.

With reference to FIG. 1, the control system 106 can manage and coordinate the operation of the chassis 102, including navigation, positioning, and data collection and transmission. While the system 100 can include onboard computing capabilities mounted directly on the chassis 102, in certain embodiments, the control system 106 can be separate from the chassis 102 to allow for the control system 106 to operate and control multiple chassis 102. For example, in a warehouse environment, the control system 106 can be located in a garage facility that serves as a central brain for managing multiple chassis 102 simultaneously. Advantageously, the control system 106 being separate from the chassis 102 can minimize a weight and physical size of the chassis 102, optimize a cooling of the chassis 102, and facilitate power efficiency across the chassis 102 in communication with the control system 106 since components of the control system 106 such as a graphic processing unit (GPU) and central processing unit (CPU) can consume significant battery power when mounted on the individual chassis 102.

By maintaining the processing capability at a central location, the system 100 can utilize high-speed communication to maintain connectivity between the control system 106 and the chassis 102. The control system 106 can be wirelessly connected to the chassis 102 to facilitate high-bandwidth communication for command and control signaling, navigating, image capturing, mission tasking, software updating, and data transferring.

It should be noted that the control system 106 can include an interface for interacting with and interfacing with the control system 106 and, specifically, the software of the control system 106. The control system 106 can use the software, as described herein, to process and compute images, statuses, commands, and data. The control system 106 can interact with the system 100 to facilitate AI and machine learning, chassis 102 shuffle on the track system 108, physical exceptions management, chassis 102 maintenance, the imaging device 104, WIFI communication, chassis 102 navigation management, battery management and charging, and storage and egress.

It should be appreciated that the control system 106 can include a memory (internal or external), which can be coupled to one or more processors for storing information and instructions that can be executed by the processor. The memory can be one or more memories and of any type suitable to the local application environment and can be implemented using any suitable volatile or nonvolatile data storage technology such as a semiconductor-based memory device, a magnetic memory device and system, an optical memory device and system, fixed memory, and removable memory. For example, the memory can consist of any combination of random-access memory (RAM), read only memory (ROM), static storage such as a magnetic or optical disk, hard disk drive (HDD), or any other type of non-transitory machine or computer readable media. The instructions stored in the memory can include program instructions or computer program code that, when executed by the process, enable the system 100 to perform tasks as described herein.

One skilled in the art will also appreciate that one or more processors can be configured for processing information and executing instructions or operations. The processor can be any type of general or specific purpose processor. In some cases, multiple processors for the at least one processor can be utilized according to other embodiments. In fact, the one or more of the processors can include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more of the processor can be remote from the control system 106, such as disposed within a remote platform.

The one or more processors can perform functions associated with the operation of the system 100 which can include, for example, precoding of antenna gain/phase parameters, encoding and decoding of individual bits forming a communication message, formatting of information, and overall control of the one or more computing platforms, including processes related to management of communication resources.

The memory can also store a plurality of modules including the machine-readable instructions, which can be provided as tangible, non-transitory processor executable instructions, as a non-limiting example. The instructions can be configured to execute a method 200 of the present disclosure as described herein, by the processor or the other processors of the system 100 as detailed hereinabove.

In certain embodiments, one or more computing platforms can also include or be coupled to one or more antennas (not shown) for transmitting and receiving signals and/or data to and from the system 100. The one or more antennas can be configured to communicate via, for example, a plurality of radio interfaces that can be coupled to the one or more antennas. The radio interfaces can correspond to a plurality of radio access technologies including one or more of LTE, 5G, WLAN, Bluetooth, near field communication (NFC), radio frequency identifier (RFID), ultrawideband (UWB), and the like. The radio interface can include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

The track system 108 can include a rail 136 that can be mounted to various infrastructure elements allowing the chassis 102 to traverse bi-directionally using guide wheels for interface with the rail 136. For example, the track system 108 can be mounted to a ceiling structure or an existing railing, as desired. In this way, the track system 108 should be lightweight enough to allow for easy installation while still providing a robust infrastructure for the system 100 during operation. A skilled artisan can select a suitable location for installation within the scope of the present disclosure. The chassis 102 can utilize the drive system 132 to facilitate enhanced movement control and positioning along the rail 136. The track system 108 can be installed across diverse environments including warehouses, distribution centers, retail stores, parking garages, airports, campuses, along expressways, at schools, shopping malls, and on building exteriors, as examples described herein. In certain embodiments, the system 100 can be adaptable and the system 100 can utilize a rigid, durable material for forming the track system 108. For example, the track system 108 can be conduit formed from electrical metallic tubing (EMT) conduit, polyvinyl chloride (PVC) conduit, rigid metal conduit (RMC), and combinations thereof. In a particular example, the track system 108 can include three-quarter inch EMT conduit. Advantageously, the material can be mounted from the ceiling of a facility, providing a robust and unobtrusive installation solution. A skilled artisan can select a suitable material for the track system 108 within the scope of the present disclosure.

It should be appreciated that multiple chassis 102 can traverse the same or different rail 136 networks of the track system 108 either autonomously or on-demand based on coverage needs. By deploying multiple chassis 102, the system 100 can efficiently monitor extensive areas with each chassis 102 operating simultaneously while communicating with the control system 106. As described herein, each chassis 102 can capture more than 1000 pictures per hour, allowing for extensive visual documentation of the monitored space. The control system 106 can manage the deployment of multiple chassis 102 by shuffling the position of each chassis 102 to ensure optimal coverage, while utilizing algorithms for efficient energy usage and collision avoidance. The multi-chassis configuration enables the system 100 to dynamically respond to monitoring needs, with the control system 106 coordinating autonomous or on-demand movement to maintain persistent surveillance. The system 100 can also integrate with warehouse systems or enterprise resource planning (ERP) systems to create dynamically prioritized missions, allowing the multiple chassis 102 to focus on high-priority areas while maintaining overall coverage.

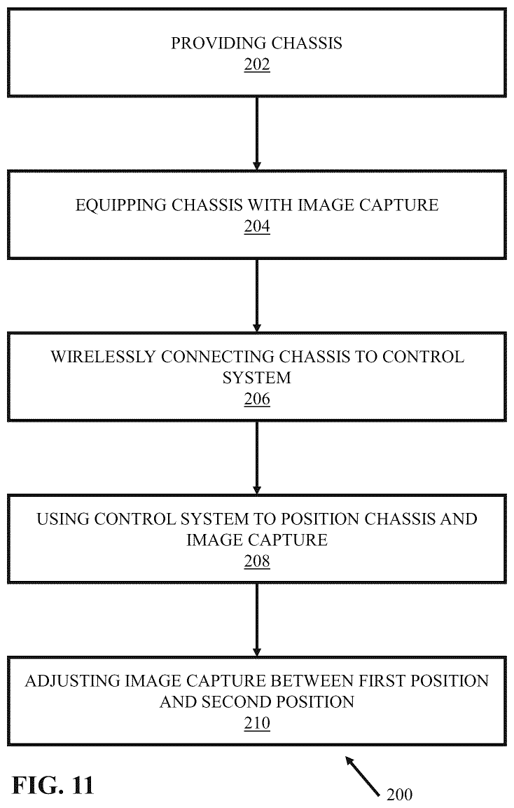

The present disclosure provides a method 200, as shown generally in the flowchart of FIG. 11. The method 200 can include a step 202 of providing the chassis 102 of the present disclosure adapted to traverse along a track system 108. The chassis 102 can be equipped with the imaging device 104 adjustably mounted to the chassis 102 in a step 204 of the method 200. In a step 206, the chassis 102 can be wirelessly connected to the control system 106 for navigation, imaging device positioning, and imaging device. The method 200 can include using the control system 106 to autonomously position the chassis 102 and the imaging device 104 within the space for imaging device in a step 208. The method 200 can include a step 210 adjusting the imaging device between the first position (A) and the second position (B), as described herein.

The system 100 offers advantages through the track system 108 and integrated imaging device 104 that militate against monitoring blind spots and enable comprehensive coverage of large spaces. The system 100 can capture thousands of pictures an hour while being managed by the control system 106, which optimizes energy usage and militates against collisions through precise navigation. Advanced features include machine learning capabilities, infrared sensors, autonomous off-hours operation, and integration with a warehouse management system.

### Examples

Example embodiments of the present technology are provided with reference to the several figures enclosed herewith.

Example embodiments of the present technology are also provided with reference to the FIGS. 7-9 enclosed herewith.

In a first example, the system 100 can be used in operation in a warehouse inventory management environment, as shown in FIG. 7. The system 100 demonstrates effectiveness in a warehouse environment where inventory tracking is required. Multiple chassis 102 traverse the ceiling-mounted track system 108, capturing between 1000-2000 images per hour to monitor up to 80,000 pallet locations.

The control system 106 coordinates chassis 102 deployment based on dynamic priorities received from the warehouse management system, enabling focused monitoring of high-turnover areas while maintaining comprehensive coverage.

During off-hours operations, the system 100 operates autonomously, utilizing the lighting capabilities and infrared sensors to maintain consistent monitoring quality. The vertically adjustable imaging device 104, positioned 5-6 feet from inventory locations, captures detailed images of standard 48×40 inch pallet positions while the chassis continues moving along the track.

The system integrates with existing the warehouse management system to create prioritized missions, automatically directing the chassis 102 to an area requiring immediate attention. Machine learning and computer vision capabilities enable automated inventory counts, object identification, and tracking, while the control system 106 in the garage facility manages data retention and analysis. The control system 106 coordinates a charging schedule across multiple chassis 102, facilitating continuous operation through automated returns to the charging station based on a mission requirement and a battery level. This enables the system 100 to maintain persistent monitoring while optimizing energy usage and preventing operational disruptions.

In a second example, the system 100 can be used in operation in a storage facility environment for monitoring, as shown in FIG. 7. In the storage facility, the system 100 provides security and inventory tracking through the network of rail-mounted chassis 102 which can operate along the track system 108. The control system 106 manages multiple chassis 102 traversing within the facility, utilizing both the imaging device 104, such as a camera, and the infrared sensor for enhanced visibility in poorly lit areas.

The ability of the system 100 to operate autonomously during off-hours is valuable in the storage facility, where after-hours security is advantageous. The chassis 102 can perform a regular patrol while capturing and processing imagery through a machine learning algorithm to detect unauthorized access or suspicious activity. The vertically adjustable camera enables monitoring of various storage unit sizes, with the ability to position sensors at optimal heights for different monitoring tasks. The control system 106 coordinates multiple chassis 102 to promote comprehensive coverage while managing power consumption through automated charging schedule.

Integration with a facility management system enables automated tracking of unit access and inventory changes, while the data retention capabilities of the system 100 maintain a record of all monitoring activities.

In a third example, the system 100 can be used in operation in warehouse, library or educational environment, where items are stored on shelving or racks, as shown in FIG. 7. In library settings, the system 100 can be adapted to monitor book inventory and patron activity. The ceiling-mounted track system 108 allows chassis units to navigate through aisles while maintaining a discreet presence above the stacks. The imaging device 104 can read text from 5-6 feet away, which enables automated book inventory management, while the control system 106 coordinates multiple chassis 102 to facilitate coverage of the facility.

The quiet operation and unobtrusive design of the system 100 make the system 100 useful for a library environment. Machine learning capabilities enable automated book identification and location tracking, while integration with the library management system allows for real-time inventory updates and location verification. The control system 106 manages data retention and analysis, maintaining records of inventory movement while coordinating chassis deployment based on priority areas identified through usage patterns.

In a fourth example, the system 100 can be used in a retail security environment, as shown in FIG. 8. In a retail environment, the system 100 provides security coverage while enabling inventory management through the network of ceiling-mounted track system 108. Multiple chassis 102 equipped with an imaging device 104 monitor store aisles and high-value areas, capturing both standard imagery and thermal data for security. The system 100 can be integrated with a point-of-sale and inventory management system to enable automated tracking of stock levels and detection of inventory discrepancies.

During operating hours, the chassis 102 maintains discrete surveillance while coordinating movement to avoid customer distraction. Machine learning capabilities enable automated detection of suspicious behavior patterns, while the control system 106 manages data retention and alert generation. Integration with an existing security system can enhance overall facility protection.

In a fifth example, the system 100 can be used in operation as exterior building security, as shown in FIG. 9. For an exterior building security application, the system 100 can be adapted to monitor a building perimeter and/or outdoor spaces. The track system 108 mounted to external building infrastructure enables the chassis 102 to patrol the building exterior while utilizing specialized sensors including FLIR (Forward Looking Infrared) for enhanced nighttime surveillance.

A weather-resistant chassis 102 traverses the track system 108 while maintaining communication with the control system 106 through high-speed wireless connection. The infrared capability of the system 100 enables detection of heat signatures, particularly valuable for identifying unauthorized presence or potential security threats. The control system 106 coordinates multiple chassis 102 to maintain comprehensive coverage of the building exterior while managing power consumption through an automated charging schedule. Integration with a building management system enables automated alert generation and response coordination.

The ability of the system 100 to operate autonomously in various weather conditions, combined with advanced sensor capabilities and machine learning-based analysis, provides exterior security monitoring while maintaining detailed records of all surveillance activities.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for tracking and monitoring, comprising:
a track system;
a chassis adapted to traverse along the track system, the chassis including
a chassis body having
a drive system for propelling the chassis along the track system,
a power source, and
a guide wheel adapted to interface with the track system, and
an image capture housing disposed adjacent the chassis body and selectively movable between a first position and a second position, the image capture housing having an imaging device; and
a control system in wireless communication with the chassis for navigation and imaging device.

2. The system of claim 1, wherein the track system includes a rail mounted to a support structure.

3. The system of claim 1, wherein the chassis includes a cable coupling the chassis body and the image capture housing.

4. The system of claim 3, wherein the chassis body and the image capture housing are in communication via the cable.

5. The system of claim 1, wherein the control system utilizes at least one of RFID and QR codes to for positioning and navigation of the chassis.

6. The system of claim 1, wherein the control system is in communication with the drive system.

7. The system of claim 1, wherein the control system includes machine learning for object identification.

8. The system of claim 1, wherein the chassis includes at least one of onboard computing, lighting, LiDAR, and audio equipment.

9. The system of claim 1, wherein the control system is in wireless communication with the chassis.

10. The system of claim 1, further including an infrared sensor disposed adjacent the imaging device.

11. The system of claim 1, wherein the chassis includes a motor for moving the image capture housing between the first position and the second position.

12. The system of claim 1, wherein the image capture housing includes a rotatable imaging device disposed centrally on the image capture housing.

13. The system of claim 1, wherein the guide wheel includes a rubberized surface for contacting the track system.

14. The system of claim 1, wherein the chassis body includes an arm having a first segment disposed at an angle relative to the chassis body and a second segment disposed at a second angle relative the first segment.

15. The system of claim 1, wherein the track system includes at least one of electrical metallic tubing (EMT) conduit, polyvinyl chloride (PVC) conduit, rigid metal conduit (RMC), and combinations thereof.

16. The system of claim 1, wherein the image capture housing includes a light source controlled by the control system.

17. The system of claim 1, wherein the imaging device includes at least one of a 3D camera, a stereo camera, a depth sensor, and a RFID sensor.

18. A method for tracking and monitoring a space, the method comprising steps of:
providing a chassis adapted to traverse along a track system;
equipping the chassis with an imaging device adjustably mounted to the chassis, and configured to raise, lower, and pivot for positioning;
wirelessly connecting the chassis to a control system for navigation and imaging device positioning; and
using the control system to autonomously position the chassis and imaging device within the space for imaging device.

19. The method of claim 18, wherein the imaging device is configured to capture between about 1000 to about 2000 images per hour.

20. The method of claim 18, further including a step of adjusting the imaging device between a first position and a second position.
